(19) United States
(12) Patent Application Publication
(10) Pub. No.: US 2006/0246410 A1
(43) Pub. Date: Nov. 2, 2006

(54) Learning support system and learning support program

(75) Inventor: Naomi Iwayama, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/187,806

(22) Filed: Jul. 25, 2005

(30) Foreign Application Priority Data
Apr. 28, 2005 (JP) 2005-132468

(51) Int. Cl. G09B 7/00

(52) U.S. Cl. 434/323

(57) ABSTRACT

A learning support system is provided in which, when the same question is displayed at the second time and afterward, the question is displayed in a form so that a previous correctness/wrongness state is understood, whereby learning effects are enhanced. The learning support system having a question display part for displaying a question fetched from a question database on a screen and an answer input part, includes an answer determining part for matching an answer inputted from the answer input part with a correct answer in the question database to determine whether or not the answer inputted from the answer input part is correct, an answer determination result display part for displaying answer determination results by the answer determining part so that they are associated with the answer inputted from the answer input part, and an answer determination result memory for storing the answer determination results so that they are associated with a question. Regarding a question whose answer determination results in the previous answering are present, the question display part displays the question in a form (e.g., coloring of an answer box) in accordance with the answer determination results in the previous answering.

### BACKGROUND OF THE INVENTION

1. Field of the Invention

The present invention relates to a learning support system in which, when an answer to a question displayed on a screen of a computer is inputted, automatic marking is performed with respect to an inputted character and numeral, and the results of the marking are displayed.

2. Description of Related Art

Conventionally, there is a system that allows a numeral, or a character or a character string to be inputted by the hand as an answer in an answer box of a question for learning displayed on a screen of a computer. In such a system, by pressing a marking button or the like, the handwriting in the answer box is recognized as a character, and matched with a correct answer to determine correctness/wrongness immediately, and correction/wrongness determination results are displayed.

For example, JP 10(1998)-177337 A discloses a method for recognizing a question handwritten on a tablet-type computer by character recognition, recognizing a handwritten answer by character recognition, and matching recognition results of the answer with a correct answer to the question to perform automatic marking, and displaying marking results.

Furthermore, JP 2004-30980 A discloses a method for recognizing an answer inputted by the hand, matching recognition results with a correct answer associated with a learning question to analyze correctness/wrongness, performing a display in accordance with correctness/wrongness results, and creating and storing correctness/wrongness history data.

Furthermore, JP 5(1993)-297793 A discloses a method for comparing an inputted handwritten character with the number of strokes, the stroke order, the shape, and the like of a previously stored character, followed by analyzing, determining correctness/wrongness totally, and displaying determination results.

### SUMMARY OF THE INVENTION

According to the above-mentioned conventional system, when an answer is inputted with respect to a question displayed on a computer, marking results are displayed immediately. However, the case where learning is repeated two or more times with respect to the same question is not taken into consideration. More specifically, in the case of repeatedly solving the same question, the same question is merely displayed repeatedly, and the same mistake is likely to be made with respect to a question to which a wrong answer has been given previously.

Therefore, with the foregoing in mind, it is an object of the present invention to provide a learning support system in which determination results with respect to an inputted answer are stored for each question, and when the same question is displayed at the second time and afterward, the question is displayed in such a manner that a correctness/wrongness state at the time of previous answering is understood to attract the attention of a leaner, whereby learning effects are enhanced.

A learning support system according to the present invention having a question storing part for storing a question identifier, a question, and a correct answer so that they are associated with each other, a question display part for displaying a question fetched from the question storing part on a screen, and an answer input part for receiving an input of an answer to the question, includes: an answer determining part for matching the answer inputted from the answer input part with the correct answer in the question storing part and determining whether or not the answer inputted from the answer input part is correct; an answer determination result display part for displaying answer determination results by the answer determining part so that they are associated with the answer inputted from the answer input part; and an answer determination result storing part for storing the answer determination results by the answer determining part so that they are associated with the question identifier, wherein the question display part displays a question whose answer determination results in previous answering are present in the answer determination result storing part, in a form in accordance with the answer determination results in the previous answering.

According to the above configuration, when the same question is displayed at the second time and afterward, the question can be displayed in a form so that a correctness/wrongness state in the previous answering is understood based on the answer determination results stored in the answer determination result storing part.

In the learning support system according to the present invention, the question display part may display the question whose answer determination results in the previous answering are present in the answer determination result storing part, in a form in accordance with the latest answer determination results. Alternatively, the answer determination result storing part may store a plurality of past answer determination results, and the question display part may display the question whose answer determination results in the previous answering are present in the answer determination result storing part, in a form in accordance with a past correctness state obtained from the plurality of past answer determination results.

In the learning support system according to the present invention, it is preferable that the answer determination result display part refers to the answer determination result storing part, and displays answer determination results in a form so as to make it understood that a question to which a wrong answer has been given in the previous learning receives a correct answer. According to this configuration, a leaner can obtain the feeling of achievement, which enhances the learning willingness of the learner. Alternatively, it is also preferable that the answer determination result display part refers to the answer determination result storing part, and displays answer determination results in a form so as to make it understood that a question to which a wrong answer has been given in the previous learning receives a wrong answer again. According to this configuration, the learner is allowed to recognize a question difficult to handle for the learner, which enhances learning effects.

In the learning support system according to the present invention, it is preferable that the question storing part stores an answer limit time of each question regarding at least a part of questions, the learning support system further includes a timer for measuring a time required from a commencement of answering a question to a completion of inputting an answer, the answer determination result storing part also stores information on whether or not the time measured by the timer exceeds the answer limit time together with the answer determination results, and the question display part refers to the answer determination result storing part and displays questions in a form so that a question whose answer limit time has been exceeded in the previous learning is recognized. According to this configuration, the learner is allowed to recognize a question difficult to handle for the learner, which enhances learning effects.

In the learning support system according to the present invention, it is preferable that, in a case where a learner designates either one of the questions, the answer determination results and information regarding the designation by the leaner are stored in the answer determination result storing part, and the question display part refers to the answer determination result storing part, and displays questions in a form so that the question designated by the learner in the previous learning is recognized. For example, regarding a question to which a correct answer has been given, and which the learner desires to learn again with special care for some reason, if the learner inputs as such, this information is stored in the answer determination result memory together with the answer determination results. According to this configuration, the learner can identify a question which he/she has desired to learn again with special care in the previous learning, which enhances learning effects.

In the learning support system according to the present invention, the answer input part may include an input device for allowing an answer to be inputted with handwriting, and the learning support system may further includes a character/string recognizing part for referring to a character recognition dictionary to perform character/string recognition from the handwriting, wherein the answer determining part may refer to the recognition results by the character/string recognizing part and the correct answer in the question storing part to determine correctness. According to this configuration, the correctness is determined even regarding an answer inputted with handwriting, and the results thereof are stored. Consequently, when the same question is set next time, the question can be displayed in a form in accordance with the answer determination results.

In the learning support system according to the present invention, it is preferable that the answer input part includes an input device for allowing an answer to be inputted with handwriting, and the answer determining part determines whether or not an answer is correct with respect to at least two elements selected from the group consisting of a shape of a character, a stroke order, the number of strokes, stop, and sweep-up, based on stroke information of the handwriting. According to this configuration, the correctness of a character inputted with handwriting is totally determined with respect to at least two elements selected from the group consisting of a shape of a character, a stroke order, the number of strokes, stop, and sweep-up, and the results thereof are stored. Consequently, when the same question is set next time, the question can be displayed in a form in accordance with the answer determination results.

Furthermore, a computer-readable recording medium according to the present invention stores a learning support program for allowing a computer to execute: a question display operation of displaying a question fetched from a question storing part storing a question identifier, a question, and a correct answer so that they are associated with each other on a screen; an input operation of receiving an input of an answer to the question; an answer determining operation of matching the inputted answer with the correct answer in the question storing part to determine whether or not the answer inputted from the answer input part is correct; an answer determination result display operation of displaying the answer determination results so that they are associated with the answer inputted from the answer input part; and an answer determination result storing operation of storing the answer determination results in an answer determination result storing part so that they are associated with the question identifier, wherein the learning support program displays a question in a form in accordance with answer determination results in previous answering, regarding a question whose answer determination results in the previous answering are present in the answer determination result storing part in the question display operation.

### BRIEF DESCRIPTION OF THE DRAWINGS

FIG. 1 is a block diagram showing a configuration of a learning support system according to Embodiment 1 of the present invention.

FIG. 2 is a flow chart showing an operation of the learning support system according to Embodiment 1.

FIG. 3 shows exemplary questions set by the learning support system according to Embodiment 1.

FIG. 4 shows a display example of the questions set by the learning support system according to Embodiment 1.

FIG. 5A shows an answer input example in the learning support system according to Embodiment 1, and FIG. 5B shows a display example of answer marking results.

FIG. 6 shows an example of answer marking results in the learning support system according to Embodiment 1.

FIG. 7 shows a display example in the case where the questions are set again in the learning support system according to Embodiment 1.

FIG. 8 is a block diagram showing a configuration of a learning support system according to Embodiment 2 of the present invention.

FIG. 9A shows exemplary questions set by the learning support system according to Embodiment 2, and FIG. 9B shows exemplary answers.

FIG. 10 shows a display example of questions in the learning support system according to Embodiment 2.

FIG. 11 shows an answer input example in the learning support system according to Embodiment 2.

FIG. 12 shows an example of answer marking results in the learning support system according to Embodiment 2.

FIG. 13 shows a display example of answer marking results in the learning support system according to Embodiment 2.

FIG. 14 shows a display example in the case where the questions are set again in the learning support system according to Embodiment 2.

FIG. 15 shows a display example of questions in a learning support system according to Embodiment 3.

FIG. 16 shows exemplary answers to the questions shown in FIG. 15.

FIGS. 17A and 17B show an answer input example in the learning support system according to Embodiment 3.

FIG. 18 shows an example of answer marking results in the learning support system according to Embodiment 3.

FIG. 19 shows a display example in the case where the questions are set again in the learning support system according to Embodiment 3.

FIG. 20 is a block diagram showing a configuration of a learning support system according to Embodiment 4 of the present invention.

FIG. 21 shows an example of stroke information stored as a correct answer pattern in the learning support system according to Embodiment 4.

FIG. 22 shows an example of stroke information inputted as answer handwriting with respect to the learning support system according to Embodiment 4.

FIG. 23 shows a correspondence relationship between the stroke of a correct answer pattern and the stroke of answer handwriting.

FIG. 24 shows exemplary questions set by the learning support system according to Embodiment 4.

FIG. 25 shows a display example of answer marking results in the learning support system according to Embodiment 4.

FIG. 26 shows an example of answer marking results in the learning support system according to Embodiment 4.

FIG. 27 shows a display example in the case where the questions are set again in the learning support system according to Embodiment 4.

FIG. 28 is a block diagram showing a configuration of a learning support system according to Embodiment 5 of the present invention.

FIG. 29A shows an answer input example in the learning support system according to Embodiment 5, and FIG. 29B shows an example of answer marking results with respect to the answer shown in FIG. 29A.

FIG. 30 shows an example of answer marking results in the learning support system according to Embodiment 5.

FIG. 31 shows a display example in the case where the questions are set again in the learning support system according to Embodiment 5.

### DETAILED DESCRIPTION OF THE INVENTION

### Embodiment 1

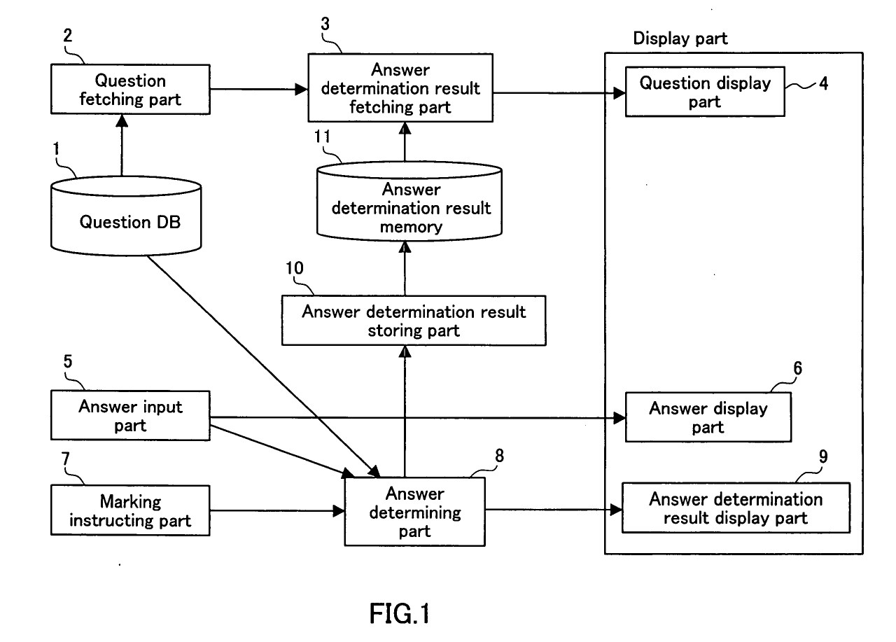

Hereinafter, a learning support system according to one embodiment of the present invention will be described with reference to the drawings. FIG. 1 is a diagram showing a configuration of the learning support system according to one embodiment of the present invention.

As shown in FIG. 1, the learning support system of the present embodiment includes a question database 1, a question fetching part 2, an answer determination result fetching part 3, a question display part 4, an answer input part 5, an answer display part 6, a marking instructing part 7, an answer determining part 8, an answer determination result display part 9, an answer determination result storing part 10, and an answer determination result memory 11. The learning support system can be realized as a computer system such as a personal computer or a server-client system.

The question database 1 stores a question number, a question, and a correct answer thereto in such a manner that they are associated with each other. The question and correct answer thereto may be stored in separate databases with a common question number. Herein, although a question number is exemplified as a question identifier, the question identifier is not limited to a number as long as each question can be identified uniquely. The question fetching part 2 fetches a question from the question database 1 and gives it to the answer determination result fetching part 3. The question display part 4 displays a question and an answer box on a display. The answer input part 5 allows a learner to input an answer with various kinds of input devices such as a keyboard, a mouse, a touch panel, or a tablet, and gives the inputted answer to the answer display part 6 and the answer determining part 8. The answer display part 6 displays the answer inputted by the learner in the answer box displayed on the display. Upon being notified of the completion of the answer input by the learner, the marking instructing part 7 gives a marking instruction to the answer determining part 8.

Upon receiving the marking instruction from the marking instructing part 7, the answer determining part 8 refers to the question database 1, and determines whether or not the answer received from the answer input part 5 is correct. The determination results by the answer determining part 8 are displayed on the display by the answer determination result display part 9, and stored in the answer determination result memory 11 by the answer determination result storing part 10 under the condition of being associated with the question number.

In the case where the same question is set at the second time and afterward, the answer determination result fetching part 3 fetches determination results with respect to the answer when the question has been learned in the past, from the answer determination result memory 11. In the case where the same question is set at the second time and afterward, the question display part 4 varies a display form of the question in accordance with the determination results with respect to the answer when the question has been learned in the past.

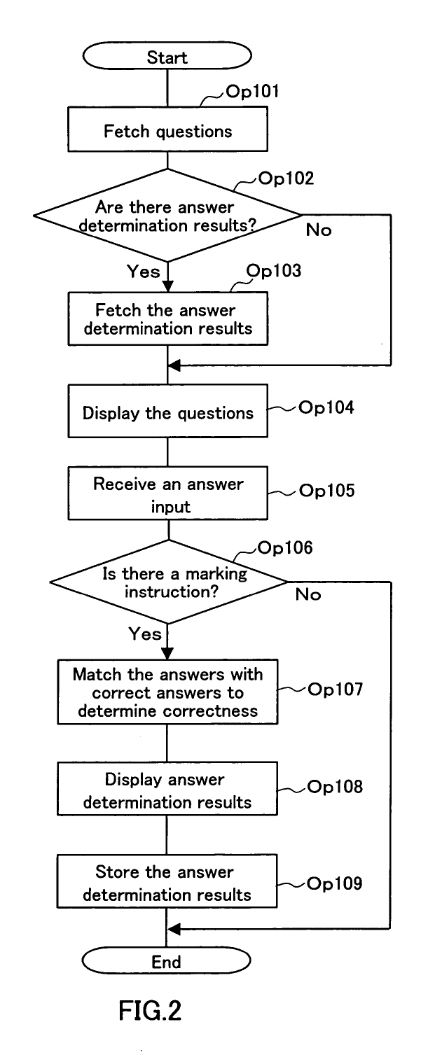

Herein, an operation flow of the learning support system according to the present embodiment will be described with reference to a flow chart shown in FIG. 2.

In FIG. 2, the question fetching part 2 fetches questions from the question database 1 (Operation Op101). Regarding questions to be fetched by the question fetching part 2, one question may be designated at a time. The following may also be performed: questions are registered in some groups, and either one of the groups is designated. Then, the answer determination result fetching part 3 checks whether or not the answer determination result memory 11 has answer determination results corresponding to the questions (Operation Op102). When there are no answer determination results (No in Operation Op102), questions are displayed based on the questions fetched from the question database 1 (Operation Op104). On the other hand, when there are answer determination results (Yes in Operation Op102), the answer determination result fetching part 3 fetches the answer determination results (Operation Op103), and a question to which a wrong answer has been given in the previous learning and a question to which a correct answer has been given at that time are displayed in such a manner that they can be discriminated from each other, based on the fetched questions and answer determination results (Operation Op104). The “wrong answer” includes both the case where an answer is wrong and the case where there is no answer to a question.

After an answer input by a user (Operation Op105), it is checked whether or not there is a marking instruction (Operation Op106). When there is no marking instruction, the processing is completed.

When there is a marking instruction, the answers in respective answer boxes are matched with correct answers (Operation Op107), and answer determination results are displayed (Operation Op108). The answer determination results are stored (Operation Op109), and the processing is completed.

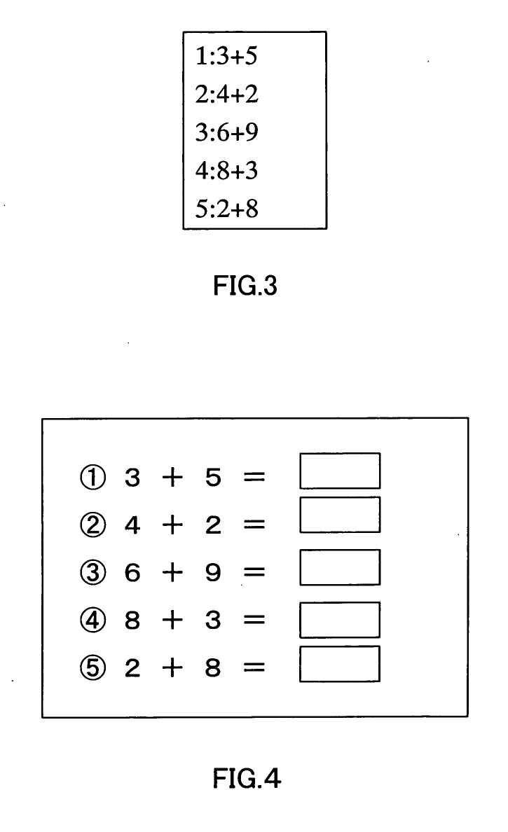

Hereinafter, the display form of a question in the learning support system of the present embodiment will be described with reference to FIGS. 3 to 7.

For example, it is assumed that numerical calculations as shown in FIG. 3 are stored in the question database 1, these questions are set for the first time with respect to a learner. In FIG. 3, numbers (1 to 5) shown on the left side of respective expressions are question numbers. In this case, the learner has not solved these questions, so that the answer determination result memory 11 does not store answer determination results with respect to these questions. Thus, the answer determination result fetching part 3 gives only the questions fetched from the question database 1 by the question fetching part 2 to the question display part 4. As a result, the question display part 4 displays these questions and answer boxes therefor, for example, in a form as shown in FIG. 4. The learner can input answers in the answer boxes using an input device such as a keyboard or a mouse. The display form shown in FIG. 4 is an example. As a display form when questions are displayed for the first time, an arbitrary display form can be adopted as long as the display form of each question is uniform without any discrimination.

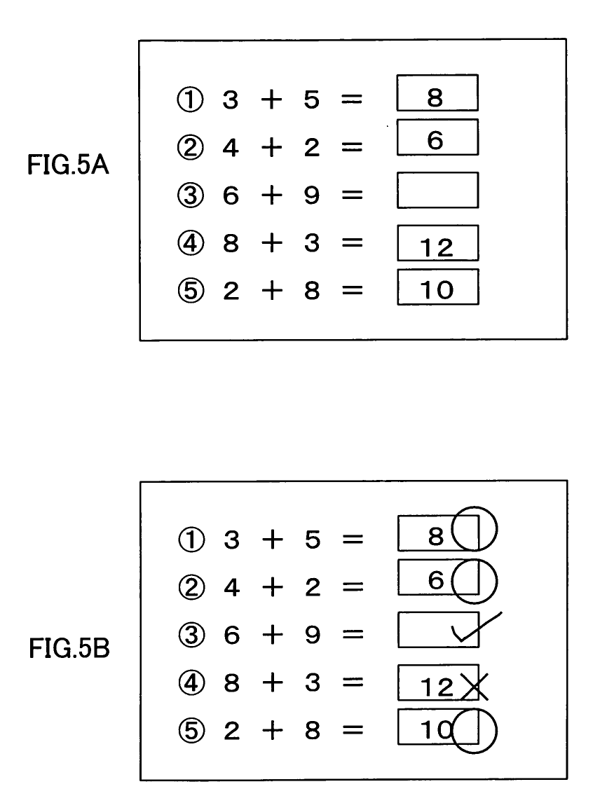

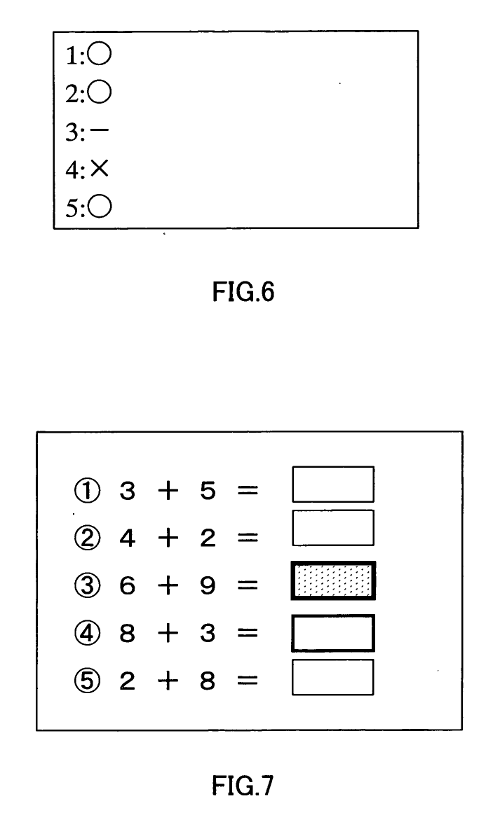

It is assumed that the learner inputs answers to these questions, for example, as shown in FIG. 5A. The answers inputted in the respective answer boxes are sent to the answer determining part 8. The answer determining part 8 obtains correct answers to be inputted in the respective answer boxes from the question database 1, and matches the data inputted in the respective answer boxes with the correct answers, thereby determining correctness. In the example shown in FIG. 5A, the answers to the first two questions and the fifth question are correct, there is no answer to the third question, and the answer to the fourth question is wrong. The answer determining part 8 sends answer determination results with respect to the respective questions to the answer determination result display part 9 and the answer determination result storing part 10 with data, for example, as shown in FIG. 6. In the example shown in FIG. 6, the correct answers are expressed as “◯”, the wrong answer is expressed as “X”, and no answer is expressed as “-”. The data representing the answer determination results are not limited to those shown in FIG. 6. Arbitrary data can be used as long as the correctness/wrongness of answers can be identified.

The answer determination result display part 9 performs a display, for example, as shown in FIG. 5B in accordance with the answer determination results with respect to the respective questions. Consequently, the leaner can know the correctness/wrongness of his/her answers. In the example shown in FIG. 5B, a symbol “◯” is displayed with respect to answer boxes in the case of correct answers, a symbol “x” is displayed with respect to an answer box in the case of a wrong answer, and a check mark is displayed with respect to an answer box in the case of no answer. The display manner of answer determination results is not limited thereto.

Furthermore, the answer determination result storing part 10 stores the data in FIG. 6 representing the answer determination results in the answer determination result memory 11 so that the data are associated with the respective question numbers. In the case of a numerical calculation of mathematics or the like, the correctness/wrongness of calculation results or no answer may be stored as the answer determination results, and in particular, numbers of the calculation results may not be stored.

After this, in the case where the questions in FIG. 3 are set again with respect to the leaner, since the previous answer determination results (data in FIG. 6) are stored in the answer determination result memory 11, the answer determination result fetching part 3 gives the questions fetched by the question fetching part 2 from the question database 1 and the previous answer determination results fetched from the answer determination result memory 11 to the question display part 4. The question display part 4 refers to the fetched questions and the answer determination results corresponding to the questions, and regarding the question to which a wrong answer has been given in the previous answering, performs a display in a form separate from those of the questions to which correct answers have been given in the previous answering.

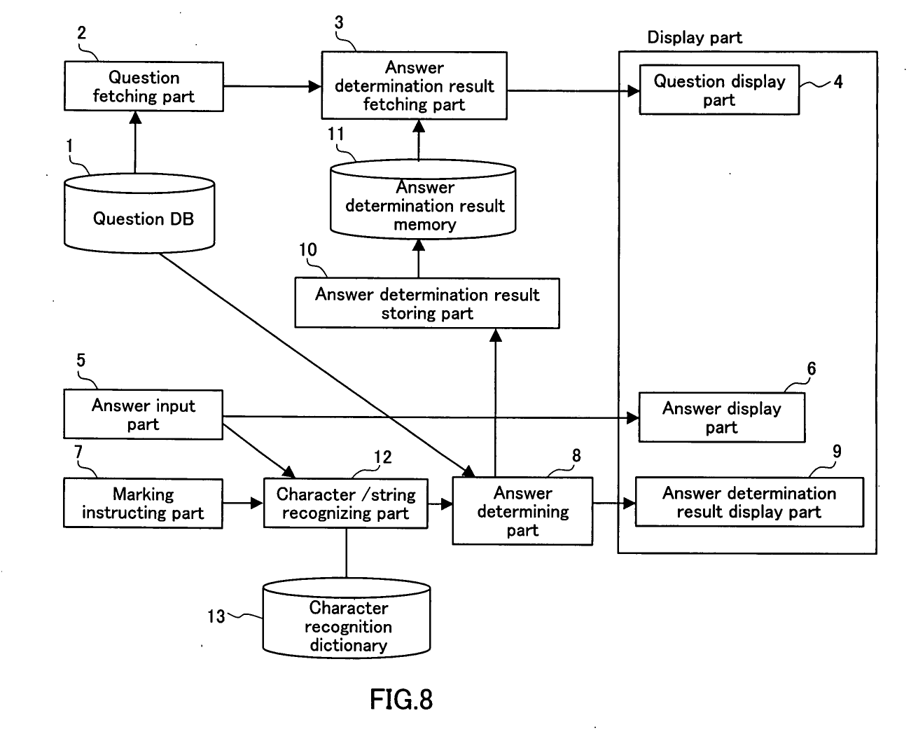

In the example shown in FIG. 7, regarding the question (third question) to which no answer has been given in the previous answering, the answer box thereof is represented with a very thick line, and a pattern (dot patter in this example) is displayed in the answer box. Regarding the question (fourth question) to which a wrong answer has been given, the answer box thereof is represented with a thick line. A manner of discriminating display forms of a question to which a correct answer has been given, a question to which a wrong answer has been given, and a question to which no answer has been given in the previous answering is not limited to only the example shown in FIG. 7. In addition to the example shown in FIG. 7, various manners can be adopted: a manner of varying colors of questions or answer boxes; a manner of displaying marks or comments different from each other in the vicinity of the questions or answer boxes; and a manner of allowing an answer box of a question, to which a wrong answer or no answer has been given, to flash.

Furthermore, in the example in FIG. 7, the questions to be set are displayed in the same order as that of the previous time. The following may also be possible: the order of questions is altered with reference to the previous answer determination results, and a question to which a wrong answer has been given or a question to which no answer has been given in the previous answering may be displayed separately.

In the case where a plurality of learners share this learning support system, the following may be performed: the learners are allowed to input user IDs before starting the use of the system, answer determination results are stored in the answer determination result memory 11 so that they are associated with user IDs for each learner, and questions are displayed referring to and reflecting the answer determination results in the previous learning for each learner.

Only the latest answer determination results may be stored in the answer determination result memory 11 for each question. In this case, the attention of the user can be attracted regarding a question to which a wrong answer has been given lastly, whereby learning effects are enhanced.

On the other hand, all the past answer determination results or a predetermined number of answer determination results may be stored in the answer determination result memory 11 for each question. In this case, since the history of the answer determination results with respect to each question is stored, so that the frequency of giving wrong answers can also be calculated for each question. Consequently, a question, to which the same wrong answer has been repeated, is displayed in a special form, a mark representing the number of wrong answers is displayed, or the like, whereby the attention of the learner can be attracted, and learning effects are enhanced.

Furthermore, the following may also be possible. The answer limit time is set for each question, and the elapsed time from the display of each question to the completion of an answer input, or the elapsed time from the learner's input of a sign for starting an answer with respect to each question to the completion of an answer input are measured with a timer or the like, and in the case where there is a question whose answer time exceeds the answer limit time, the information thereon is stored in the answer determination result memory 11 together with the answer determination results. When the same questions are displayed next, regarding the question that has taken a long time in the previous answering, the question display part 4 displays the question in a display form different from that of the other questions. According to this configuration, the attention of the learner can be attracted even with respect to the question that has taken a long time in the previous answering, learning effects are enhanced.

Furthermore, the following may also be possible. Regarding a question to which a correct answer has been given, and which a learner desires to learn again with special care for some reason, if the learner inputs (for example, puts a circle at a question number, underline a question, etc.) as such, this information is stored in the answer determination result memory 11 together with the answer determination results. Then, when the same question is displayed next, the question display part 4 displays the question in a display form different from that of the other questions. In this case, a question designating part is provided so as to confirm a designated question, and a flag representing the designated question may be provided in the answer determination result memory 11. According to this configuration, since the learner can identify the question which he/she desires to learn again with special care in the previous learning, so that learning effects are enhanced.

Furthermore, when the answer determination result display part 9 displays answer determination results, in the case where the answer determination result display 9 refers to the past answer determination results and finds that the answer to the question, to which a wrong answer has been given in the previous learning, is correct, the answer determination result display part 9 may display as such in a special form. Consequently, it can be explicitly shown that the learner comes to be able to solve the question to which a wrong answer has been given, whereby the learning willingness of the leaner can be enhanced.

Furthermore, when the answer determination result display part 9 displays answer determination results, in the case where the answer determination result display part 9 refers to the past answer determination results and finds that the answer to the question, to which a wrong answer has been given in the previous learning, is wrong again, the answer determination result display part 9 may display as such in a special form. Consequently, the question to which wrong answers have been given repeatedly can be explicitly shown, and the leaner is allowed to recognize that he/she needs to learn that question in particular,

In the present embodiment, the configuration and operation of the learning support system that is one aspect of the present invention have been illustrated. For example, a program for allowing a computer to execute the operation shown in FIG. 2, or a computer-readable recording medium storing such a program are also one aspect of the present invention. This also applies to each embodiment described later.

### Embodiment 2

Another embodiment of the present invention will be described with reference to the drawings. The components having the same functions as those described in Embodiment 1 are denoted with the same reference numerals as those therein, and the description thereof will be omitted here.

The learning support system according to the present embodiment can input an answer as a handwritten character with a pen device or the like. Therefore, the learning support system according to the present embodiment further includes a character/string recognizing part 12 and a character recognition dictionary 13 in addition to the learning support system according to Embodiment 1, as shown in FIG. 8. Due to such a configuration, in the case where an answer is inputted by the hand using a pen device or the like, the character/string recognizing part 12 performs character/string recognition from answer handwriting using the character recognition dictionary 13. Then, the answer determining part 8 matches the character/string recognition results with a correct answer to determine correctness/wrongness.

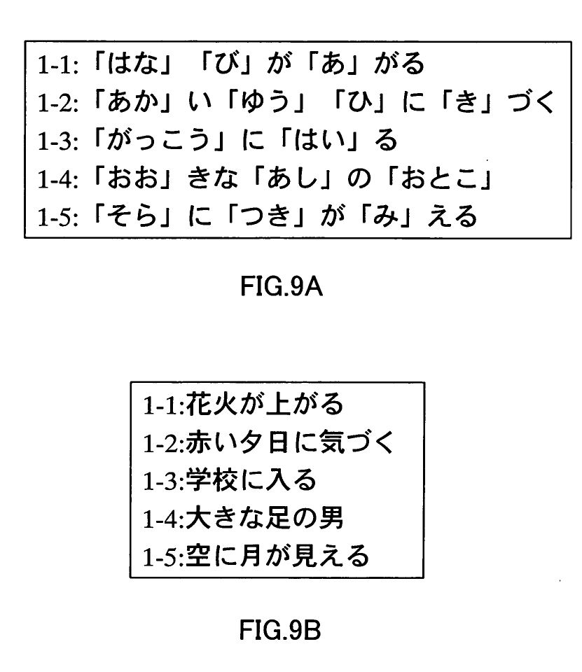

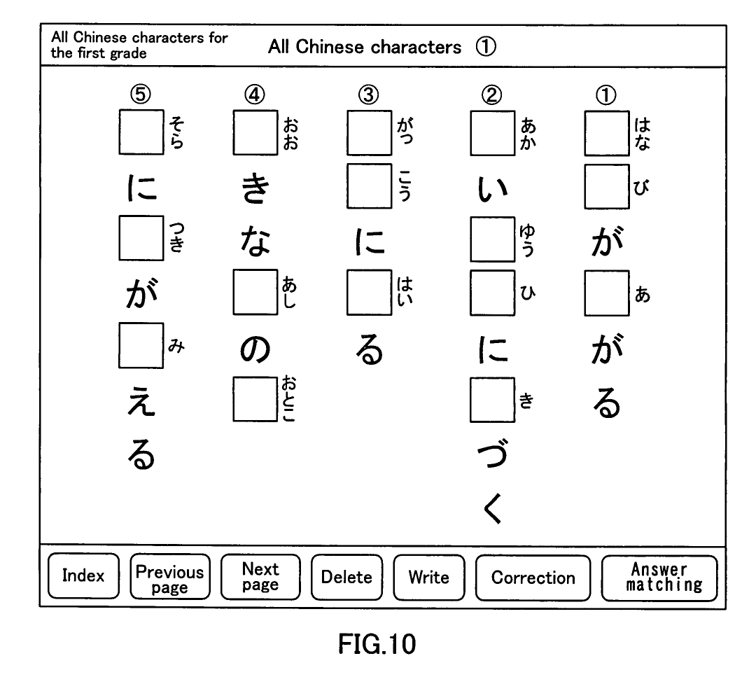

Herein, for example, the case is assumed where data of questions and answers as shown in FIGS. 9A and 9B are given. The questions shown in FIG. 9A are those for allowing a learner to write Japanese syllabaries described in parentheses in Chinese characters. The question display part 4 displays the Japanese syllabaries described in parentheses on the sides of answer boxes as the fetching of Chinese characters. A learner inputs Chinese characters in the answer boxes shown in FIG. 10 using a pen device or the like.

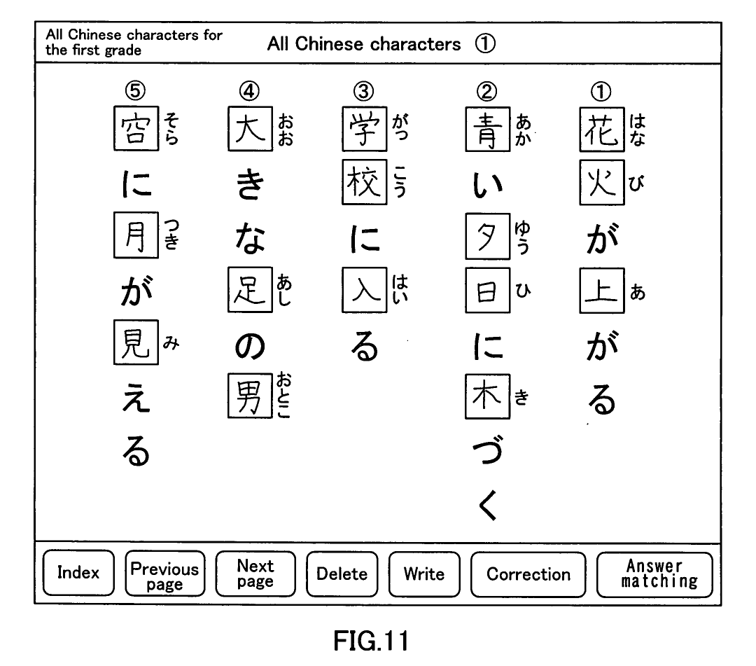

Herein, it is assumed that the learner has inputted answers as shown in FIG. 11. When the learner clicks on a button “Answer matching” displayed at a lower right end of the screen in FIG. 11, the answer determining part 8 matches the recognition results by the character/string recognizing part 12 with correct answers in the question database 1 to determine correctness/wrongness. In this example, it is determined that answers to [symbol] and [symbol] in the second question, and [symbol] in the fifth question are wrong.

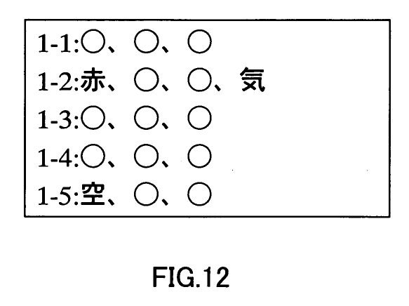

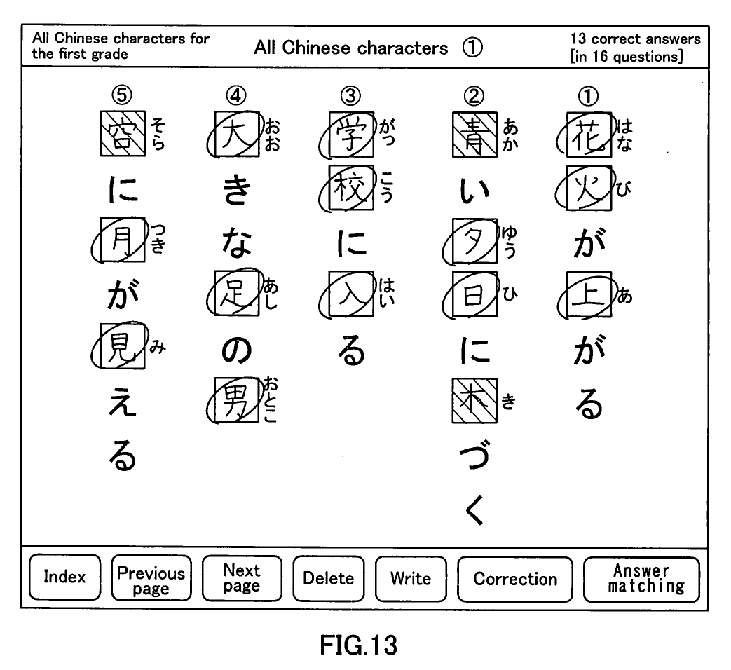

The determination results by the answer determining part 8 are expressed, for example, as shown in FIG. 12. In the example shown in FIG. 12, although circles are placed in positions of correct answers, and correct Chinese characters are placed in positions of wrong answers, any form may be used as long as the correctness/wrongness is determined. The determination results by the answer determining part 8 are given to the answer determination result display part 9, and answer determination results are shown to the learner, for example, in a form as shown in FIG. 13. In the example shown in FIG. 12, circles are displayed in the answer boxes of the correct answers. In the answer boxes of wrong answers, circles are not displayed, and the answer boxes are displayed in a color (e.g., red). The display example of the answer determination results is not limited to only this form.

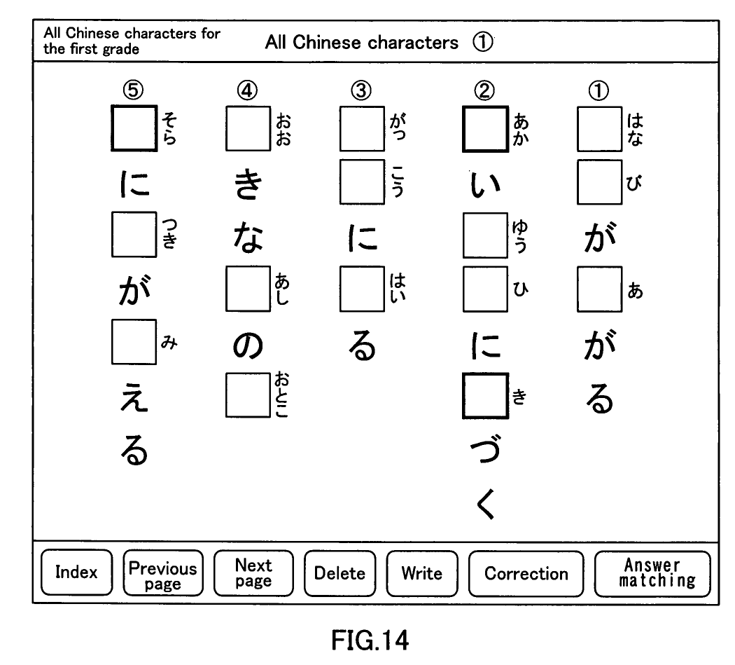

Furthermore, in the case where the same question is set again, the answer determination result fetching part 3 fetches the answer determination results from the answer determination result memory 11 and gives them to the question display part 4, whereby the questions are displayed in a form as shown in FIG. 14. In the example shown in FIG. 14, the answer boxes in which the wrong answers have been given previously [symbol] and [symbol] in the second question, and [symbol] in the fifth question) are displayed in a color (e.g., red) different from that of the answer boxes in which the correct answers have been given previously. In FIG. 14, a state where the answer boxes in which the wrong answers have been given previously are displayed in red is represented with thick lines. In the case of displaying the questions at the second time and afterward, the display form of the portions in which the wrong answers have been given previously is not limited to the use of a color different from that of the portions in which the correct answers have been given previously, as described above. For example, the type of a line of an answer box may be varied, the line of an answer box may be flashed, or the like. More specifically, the display form of an answer box in which a wrong answer has been given previously may be different from the display form of an ordinary answer box, and there is no particular limit to a manner. Furthermore, instead of changing the display form of an answer box, comments may be displayed in the vicinity of an answer box in which a wrong answer has been given previously, or the like.

Accordingly, the learner can understand that the answers in these portions are wrong at the previous learning, so that the learner comes to find out an answer carefully, which enhances learning effects. A manner of discriminating the display form of a portion in which a correct answer has been given previously from the display form of a portion in which a wrong answer has been given previously is not limited to this example.

### Embodiment 3

Still another embodiment of the present invention will be described below with reference to the drawings. The components having the same functions as those described in each of the above embodiments are denoted with the same reference numerals as those therein, and the description thereof will be omitted here.

The learning support system according to the present embodiment can input an answer as a handwritten character with a pen device or the like. Therefore, the learning support system according to the present embodiment further includes a character/string recognizing part 12 and a character recognition dictionary 13 in addition to the learning support system according to Embodiment 1, as shown in FIG. 8. Due to such a configuration, in the case where an answer is inputted by the hand using a pen device or the like, the character/string recognizing part 12 performs character/string recognition from answer handwriting using the character recognition dictionary 13. Then, the answer determining part 8 matches the character/string recognition results with a correct answer to determine correctness/wrongness.

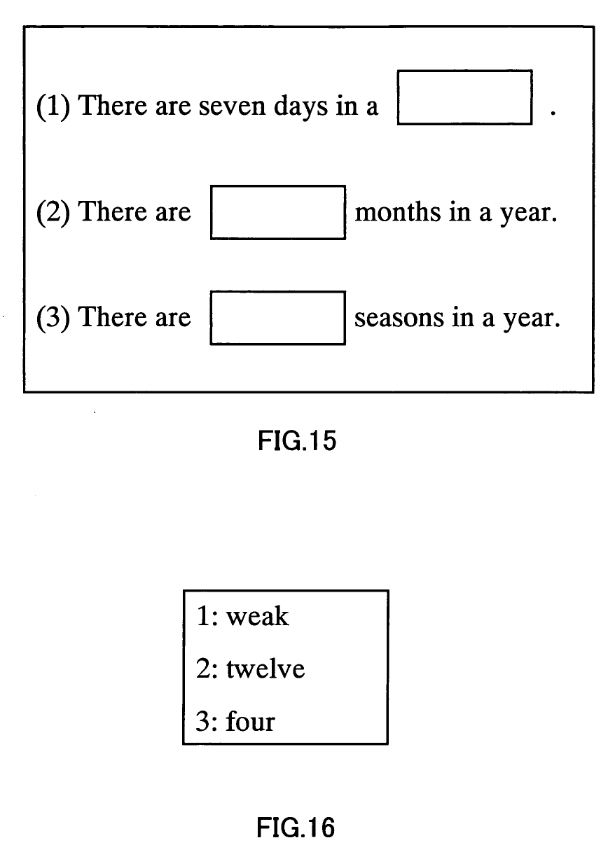

Herein, for example, the case is assumed where data of questions as shown in FIG. 15 and data of correct answers as shown in FIG. 16 are given. The questions and correct answers are stored in the question database 1 so that they are associated with question numbers. The questions shown in FIG. 15 are those for allowing appropriate English words to be written in blank square boxes. The learner inputs English words in answer boxes displayed on a screen of a display as shown in FIG. 15, using a pen device or the like.

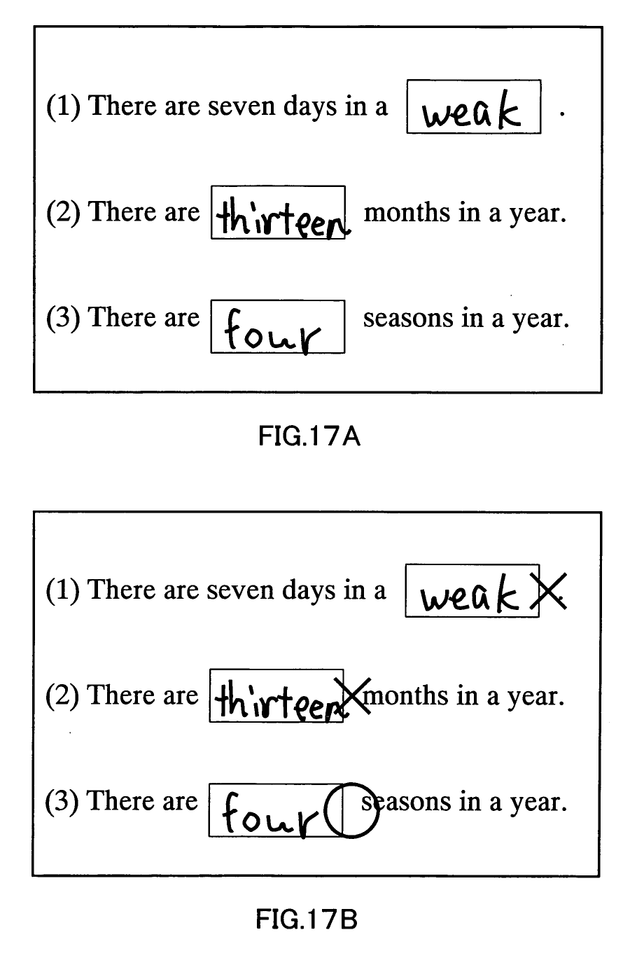

Herein, it is assumed that the learner has inputted answers as shown in FIG. 17A. When the learner clicks on a button for marking instruction, the answer determining part 8 matches the recognition results by the character/string recognizing part 12 with correct answers in the question database 1 to determined correctness/wrongness. In this example, it is determined that an answer “weak” to the first question and an answer “thirteen” to the second question are wrong.

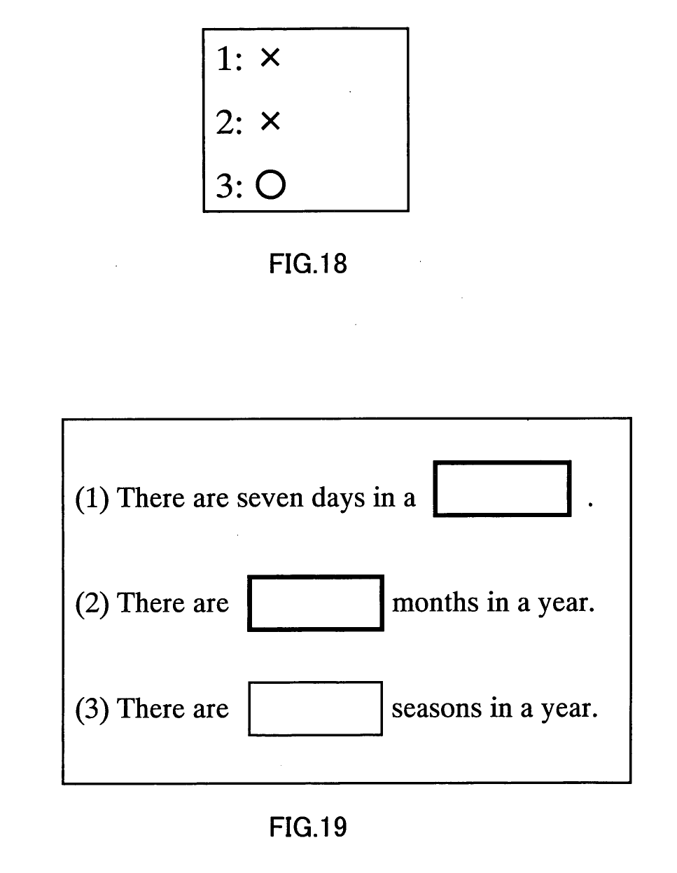

The determination results by the answer determining part 8 (see FIG. 18) are given to the answer determination result display part 9, and answer determination results are shown to the learner, for example, in a form as shown in FIG. 17B. In the example shown in FIG. 18, a correct answer is displayed as “◯”, and wrong answers are displayed as “X”. The data representing the answer determination results are not limited to those shown in FIG. 18, and arbitrary data can be used as long as correctness/wrongness of an answer is identifiable. Furthermore, the display form of the answer determination results is not limited to the form shown in FIG. 17B.

Furthermore, in the case where the same question is set again, the answer determination result fetching part 3 fetches the answer determination results from the answer determination result memory 11 and gives them to the question display part 4, whereby the questions are displayed in a form as shown in FIG. 19. In the example shown in FIG. 19, the answer boxes in which wrong answers have been given previously (first and second questions) are displayed in a color (e.g., red) different from that of the answer boxes in which correct answers have been given previously. In FIG. 19, the state where the answer boxes in which the wrong answers have been given previously are displayed in red is represented with thick lines.

Accordingly, the learner can understand that the answers in these portions are wrong at the previous learning, so that the learner comes to find out an answer carefully, which enhances learning effects. A manner of discriminating the display form of a correct answer portion from the display form of a wrong answer portion is not limited to this example.

### Embodiment 4

Still another embodiment of the present invention will be described below with reference to the drawings. The components having the same functions as those described in each of the above embodiments are denoted with the same reference numerals as those therein, and the description thereof will be omitted here.

In the learning support system according to Embodiment 4, regarding a question for which there are a plurality of kinds of reasons for wrongness, in the case where an answer is wrong, the reason why the answer is wrong is also stored as determination results. In the case where the same question is set again, regarding a question to which a wrong answer has been given, the question is displayed in a form so that the reason why the answer has been wrong is understood. Regarding a question for which there are a plurality of kinds of reasons for wrongness, for example, there is a question of the writing of a character. For example, in the case of a question where a Chinese character is written under the condition that the fetching thereof is given, there are a plurality of reasons for wrongness: a character that is not matched with the fetching of the character is inputted (i.e., the shape of the character is wrong); the number of strokes is wrong; the stroke order is wrong; stop, sweep-up, and the like are not written correctly, etc. Thus, in the case of learning the same question two or more times repeatedly, if the question is displayed in a form so that the reason why the previous answer has been wrong (for example, the stroke order has been wrong) is understood, the learner comes to pay attention to the stroke order, which enhances learning effects.

Hereinafter, regarding the configuration and operation of the learning support system of the present embodiment, the case of setting a written test of Chinese characters will be exemplified. The usage of the learning support system of the present invention is not limited to only the written test of Chinese characters, and the present invention can be applied to an arbitrary question where there are a plurality of kinds of reasons for wrongness.

The learning support system according to the present embodiment can input an answer as a handwritten character using a pen device or the like. The learning support system further evaluates the correctness of a character, regarding the shape of a character inputted by the hand, the number of strokes thereof, the stroke order thereof, stop, sweep-up, and the like, and determines correctness based on this evaluation. Furthermore, when the same question is displayed at the second time and afterward, in the case where the character inputted by the hand previously as an answer to the same question has been wrong, the question is displayed in a form so as to make it understood in which element of the shape of a character, the number of strokes, the stroke order, stop, sweep-up, and the like, the previous answer has been wrong.

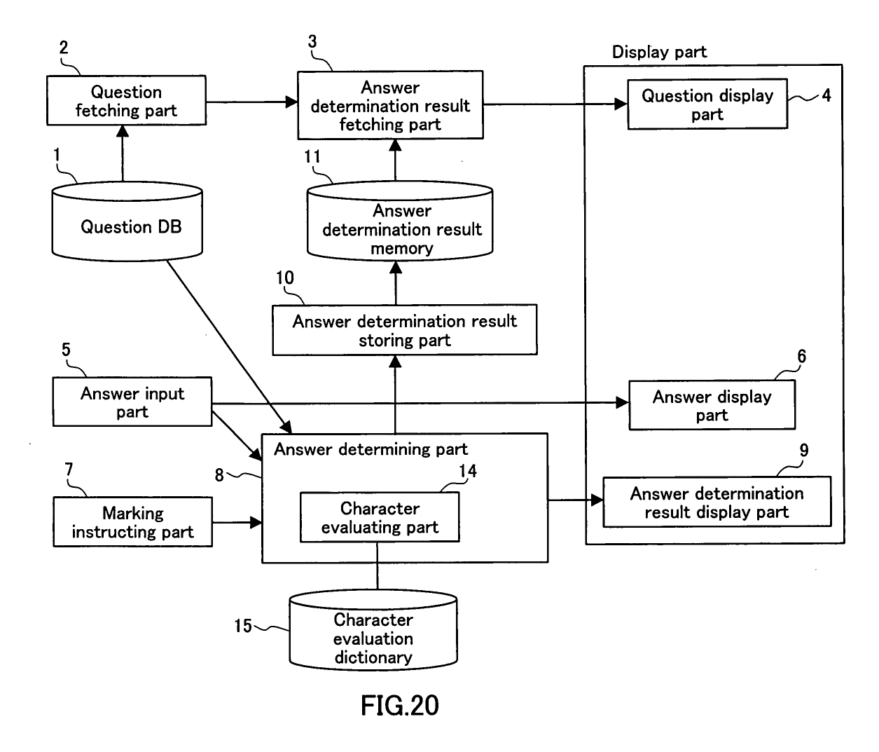

Therefore, the learning support system according to the present embodiment includes a character evaluation dictionary 15, as well as a character evaluating part 14 in the answer determining part 8, as shown in FIG. 20. The character evaluating part 14 refers to the character evaluation dictionary 15 and a correct answer in the case of learning Chinese characters and the like, thereby totally evaluating the correctness of a character regarding the shape of a character, the stroke order, the number of strokes, stop, sweep-up, and the like.

Herein, a method for totally evaluating the total correctness of a character in the character evaluating part 14 of the present embodiment will be described in detail.

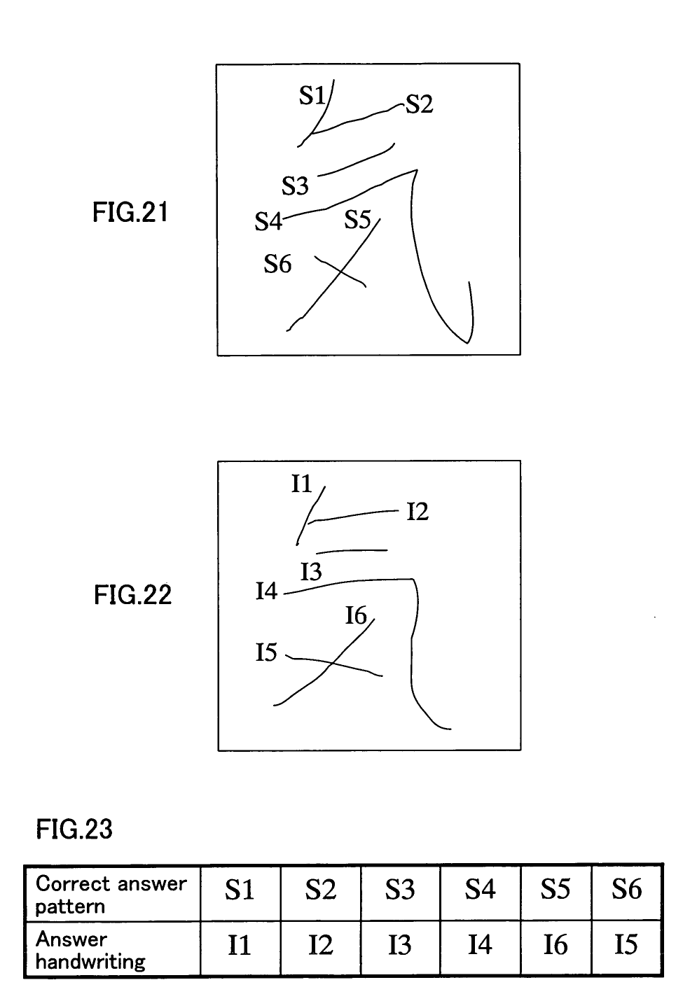

In the character evaluation dictionary 15, as shown in FIG. 21, stroke data in a time sequence in the case of a correct stroke order is stored as a correct answer pattern of each character. In FIG. 21, S1 to S6 represent the stroke order. FIG. 22 shows an example of stroke data in a time sequence inputted as answer handwriting of [symbol] . In FIG. 22, I1 to I6 represent the order of inputted strokes.

First, based on the respective positions and directions of the inputted strokes I1 to I6, it is determined which of the strokes S1 to S6 forming a correct answer pattern, each of the strokes I1 to I6 corresponds to. According to the example in FIGS. 21 and 22, a correspondence relationship as shown in FIG. 23 is obtained. The correspondence relationship between the inputted strokes and the strokes of a correct answer pattern is obtained, for example, by a method in “On-line character recognition that does not depend upon the number of strokes/stroke order by selective stroke combination”, The Institute of Electronics, Information and Communication Engineers, Proceedings, J66-D, No. 5, pp. 593-600 (1983-05), by K. KODAKA, T. WAKAHARA, and M. UMEDA

Next, the character evaluating part 14 obtains the similarity between each of the strokes S1 to S6 of the correct answer pattern registered in the character evaluation dictionary 15, and the inputted strokes I1 to 16 corresponding to the strokes S1 to S6. For example, when the similarity of all the strokes is a predetermined threshold value or more, it is determined that the inputted character is correct. In the case where there is a stroke whose similarity is smaller than a predetermined threshold value, it is determined that the shape of an inputted character is not correct. Thus, the correctness/wrongness of the shape of a character can be performed.

Furthermore, the character valuating part 14 compares each of the strokes S1 to S6 of the correct answer pattern with the inputted strokes I1 to I6 corresponding thereto, and checks whether or not the directions of trailing ends of the strokes are matched. In the case where the directions of the trailing ends are not substantially matched, it is determined that stop or sweep-up is wrong. In the case where the directions of the trailing ends are substantially matched, it is determined that stop or sweep-up is correct. Thus, the correctness/wrongness of stop and sweep-up can be determined.

Furthermore, when the input order of each of the strokes S1 to S6 of the correct answer pattern is matched with the input order of the input strokes I1 to I6 corresponding to the strokes S1 to S6, the character evaluating part 14 determines that the stroke order is correct. When the input order is different, the character evaluating part 14 determines that the stroke order is wrong. Thus, the correctness/wrongness of the stroke order can be determined.

In the case where the stroke number of the correct answer pattern is equal to the stroke number of the answer handwriting, the character evaluating part 14 determines that the number of strokes is correct. In the case where the stroke number of the correct answer pattern is different from the stroke number of the answer handwriting, the character evaluating part 14 determines that the number of strokes is wrong. Thus, the correctness/wrongness of the number of strokes can be determined.

As described above, the character evaluating part 14 determines correctness/wrongness regarding a plurality of kinds of elements such as the shape, stroke order, number of strokes, stop and sweep-up. When determining correctness in all the elements, the character evaluating part 14 determines that the answer is correct. When determining wrongness in either one of the elements, the character evaluating part 14 determines that the answer is wrong with respect to that element.

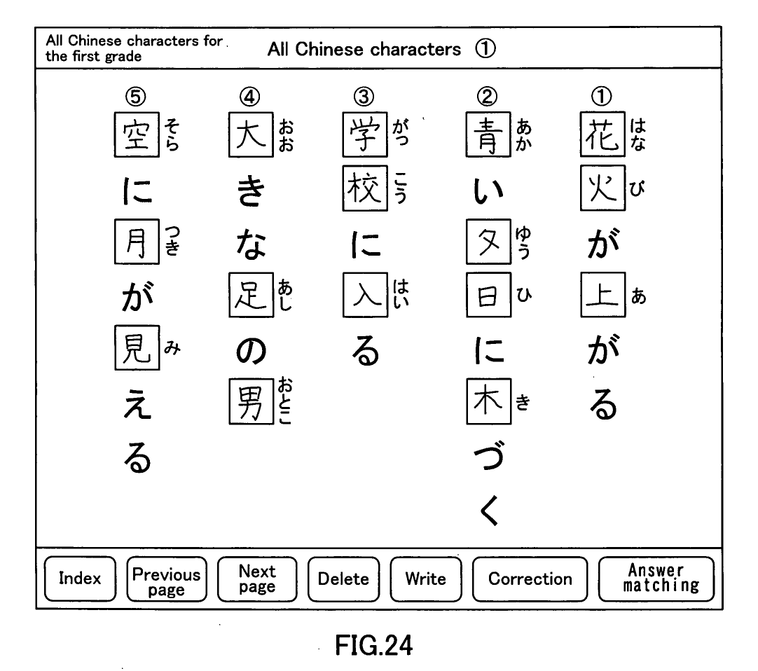

Herein, for example, as shown in FIG. 24, it is assumed that answers to five questions are inputted. It is assumed that, among the answers shown in FIG. 24, a Chinese character inputted in an answer box corresponding to a Japanese syllabary [symbol] in the first question is correct with respect to the shape of a character, but wrong with respect to the stroke order. Furthermore, regarding the second question, a Chinese character [symbol] is inputted in an answer box corresponding to the fetching of the character [symbol] and hence, the shape of a character is wrong. A Chinese character inputted in an answer box corresponding to the fetching of the character [symbol] in the second question is wrong in the way of crossing of lines. A Chinese character inputted in an answer box corresponding to the fetching of the character [symbol] in the second question is wrong in the shape of the character. Furthermore, all the answers to the third and fourth questions are correct, and regarding the fifth question, a Chinese character inputted in an answer box corresponding to the fetching of the character [symbol] is wrong in the shape of a character.

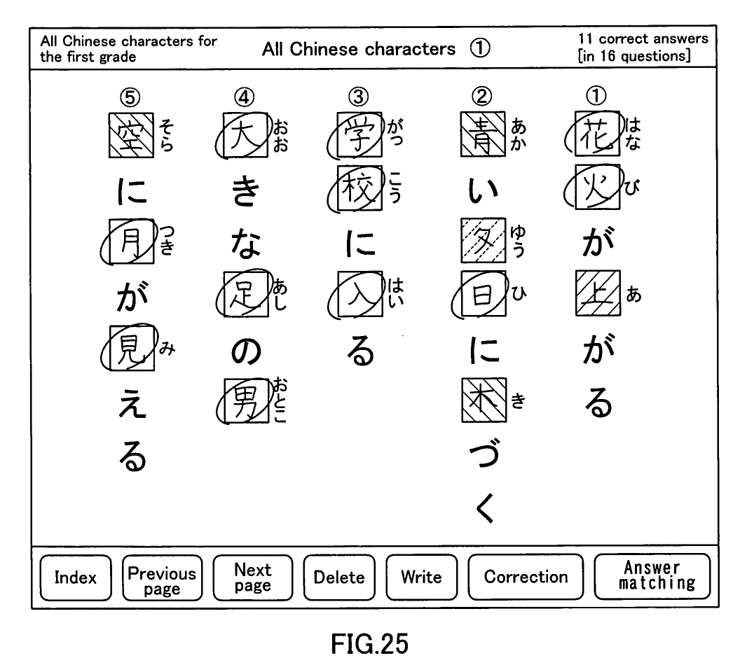

Herein, when the learner clicks on a button “Answer matching” displayed at a lower right end of a screen in FIG. 24, the answer determination result display part 9 displays answer determination results, for example, in a form as shown in FIG. 25. In the example shown in FIG. 25, circles are displayed in answer boxes of correct answers, and portions of wrong answers are displayed in forms different from each other depending upon the reason for wrongness. More specifically, regarding a portion where the stroke order is wrong (answer to [symbol] in the first question), the answer box is displayed in blue. In FIG. 25, the answer box of the portion where the stroke order is wrong is displayed in blue with left backslash solid-line hatching. Regarding portions where the shape of a character is wrong (answers to [symbol] and [symbol] in the second question, and [symbol] in the fifth question), the answer boxes are displayed in red. In FIG. 25, the answer boxes of the portions where the shape of a character is wrong are displayed in red with right backslash solid-line hatching. Furthermore, the portions where the way of crossing of lines is wrong (answer to [symbol] in the second question) are displayed in yellow. In FIG. 25, the portions where the way of crossing of lines is wrong are displayed in yellow with left backslash broken-line hatching.

Furthermore, in the display example shown in FIG. 25, in addition to coloring display in accordance with reasons for wrongness, the following may be performed. A symbol “?” or the like is displayed in the vicinity (e.g., upper right corner in an answer box) of an answer box of a wrong answer, and when the learner clicks on this symbol, comments on the reason for wrongness and cautions or hints for answering, etc. are popped up. Thus, the answer determination result display part 9 varies the display form of answer determination results in accordance with the reason for wrongness, the learner can know the reason which he/she has given a wrong answer.

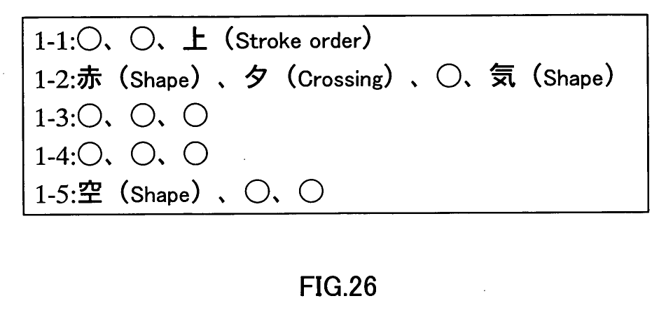

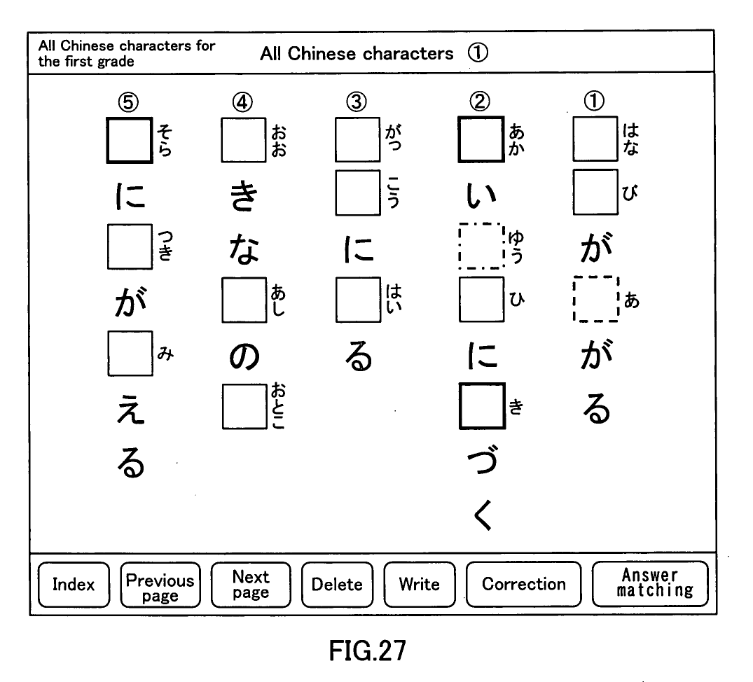

Furthermore, the answer determination results with respect to these questions are stored in the answer determination result memory 11 via the answer determination result storing part 10 in a form as shown in FIG. 26. Herein, regarding the portions of wrong answers, correct characters and reasons for wrongness are shown. However, stroke information inputted in place of a correct character is stored, and a previous wrong character may be displayed, if required. Then, when the same question is displayed next, the answer determination result fetching part 3 fetches the answer determination results from the answer determination result memory 11, and displays the questions in such a manner as to make it understood for which reasons (the shape of a character, the stroke order, the number of strokes, stop, sweep-up, etc.) wrong answers have been given, for example, in a form as shown in FIG. 27.

In the example shown in FIG. 27, regarding the portion (“ [symbol] ” in the first question) where the stroke order has been wrong in the previous answering, the answer box is displayed in blue. In FIG. 27, a blue line is represented with a broken line. Furthermore, regarding the portions ( [symbol] and [symbol] in the second question, and [symbol] in the fifth question) where the shape of a character has been wrong in the previous answering, the answer boxes are displayed in red. In FIG. 27, the red line is represented with a thick line. Furthermore, regarding the portion ( [symbol] in the second question) where the way of crossing lines has been wrong in the previous answering, the answer box is displayed in yellow. In FIG. 27, the yellow line is represented with an alternate long and short dash line. The display form in accordance with the reason for wrongness is not limited to only the example shown in FIG. 27, and an arbitrary display form can be adopted under the condition that reasons of wrongness can be discriminated from each other.

As described above, according to the present invention, a learning support system can be provided, in which answer determination results are stored in a form corresponding to a question, and the previous answer determination results are referred to, whereby in the case of displaying the same questions, what kind of mistakes have been made in the previous learning is displayed separately. Thus, by displaying the kinds of the previous mistakes separately, the learner comes to give answers, paying attention to the questions to which the learner has given wrong answers, and the learner can acquire the learned matter thoroughly without repeating the same mistake.

### Embodiment 5

Still another embodiment of the present invention will be described below with reference to the drawings. The components having the same functions as those described in each of the above embodiments are denoted with the same reference numerals as those therein, and the description thereof will be omitted here.

In the learning support system according to Embodiment 5, regarding a question for which there are a plurality of kinds of reasons for wrongness, in the case where an answer is wrong, the reason why the answer is wrong is also stored as determination results. In the case where the same question is set again, regarding a question to which a wrong answer has been given previously, the question is displayed in a form so that the reason why the answer has been wrong previously is understood. Regarding a question for which there are a plurality of kinds of reasons for wrongness, for example, there is a question of the spelling of an English word. For example, in the case of a question where an English word is written, there are a plurality of reasons for wrongness: an unsuitable English word is inputted (more specifically, a word is not correct), and a word is misspelled Thus, in the case of learning the same question two or more times repeatedly, if the question is displayed in a form so that the reason for the previous wrong answer (for example, the spelling has been wrong) is understood, the learner comes to pay attention to the spelling, which enhances learning effects.

Hereinafter, regarding the configuration and operation of the learning support system of the present embodiment, the case of setting a written test of English characters will be exemplified. The usage of the learning support system of the present invention is not limited to only the written test of English words, and the present invention can be applied to an arbitrary question where there are a plurality of kinds of reasons for wrongness.

The learning support system according to the present embodiment can input an answer as a handwritten character using a pen device or the like. Furthermore, the learning support system determines whether or not the inputted word by the hand is misspelled, and determines correctness based on that determination. Furthermore, when the same question is displayed at the second time and afterward, in the case where the character inputted previously by the hand as an answer to the same question has been wrong, the question is displayed in such a form as to make it understood in which element of the word, spelling, and the like, the previous answer has been wrong.

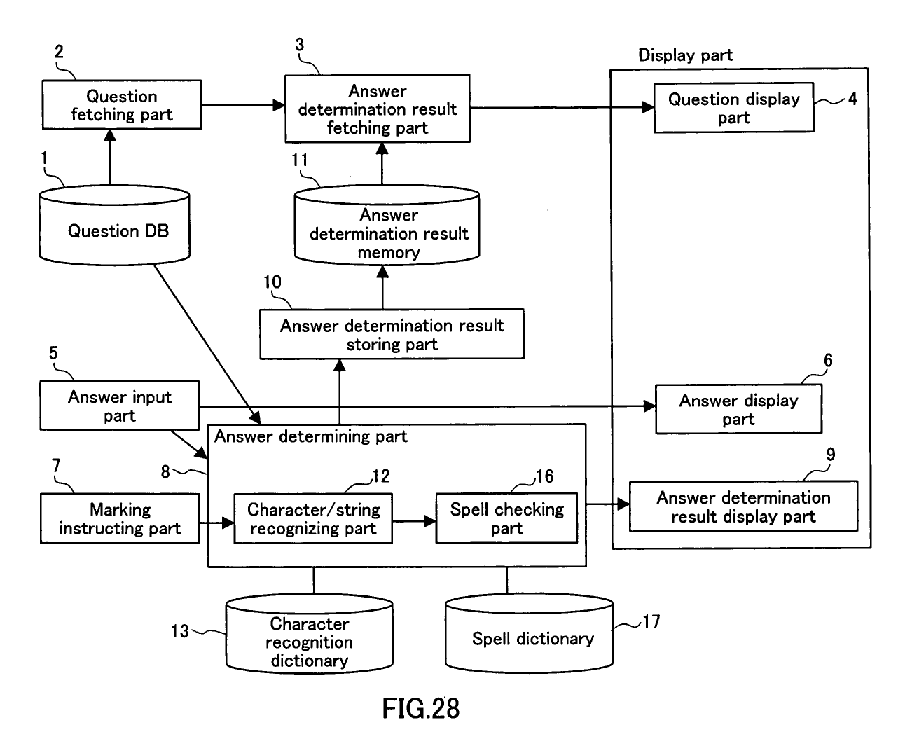

Therefore, the learning support system according to the present embodiment includes the character/string recognition dictionary 13 and a spelling dictionary 17, as well as the character/string recognizing part 12 and a spell checking part 16 in the answer determining part 8, as shown in FIG. 28. In the case of performing the learning of a question for allowing the learner to write an English word, the spell checking part 16 refers to the spell dictionary 17 and an English word obtained as the recognition results, and determines whether or not misspelling is performed. A method for checking a spell can be performed by the same method as that for checking a spell incorporated in a conventional word processing apparatus and the like.

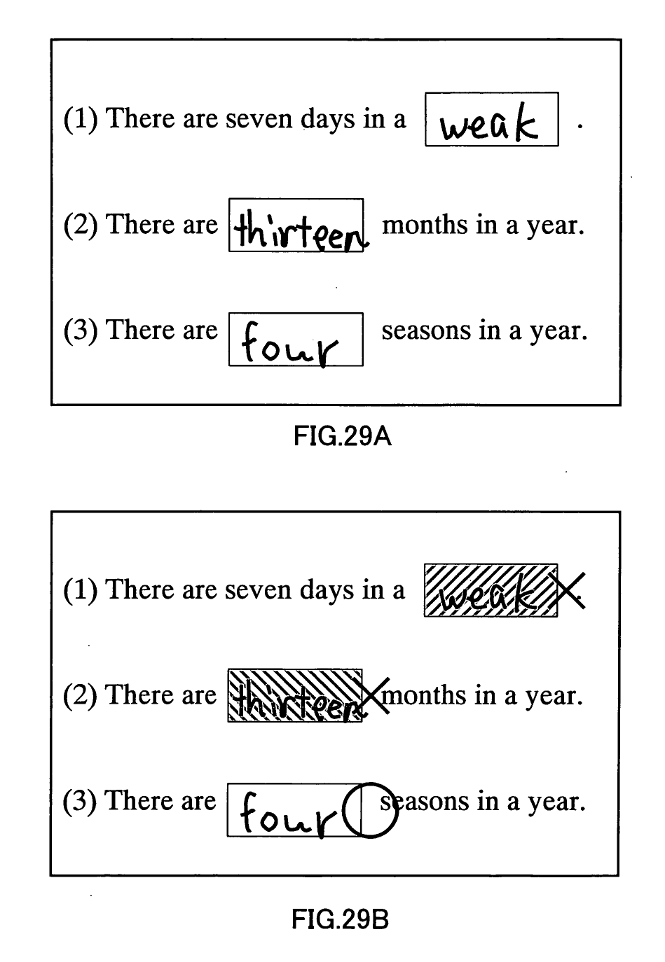

Herein, for example, as shown in FIG. 29A, it is assumed that answers have been inputted with respect to three questions. Among the answers shown in FIG. 29A, an English word “weak” inputted in an answer box for the first question is misspelled. Regarding the second question, an English word “thirteen” has been inputted in an answer box, and in this case, the word itself is wrong.

Herein, when the learner clicks on a button for marking instruction, the answer determination result display part 9 displays answer determination results, for example, in a form as shown in FIG. 29B. In the example shown in FIG. 29B, a circle is displayed in an answer box corresponding to a correct answer, and portions of wrong answers are displayed in forms different from each other depending upon the reason for wrongness. More specifically, regarding the portion of misspelling (answer to the first question), the answer box is displayed in yellow. In FIG. 29B, the yellow color is represented with left backslash solid-line hatching. Furthermore, regarding the portion of a wrong word (answer to the second question), the answer box is displayed in red. In FIG. 29B, red color is represented with right backslash solid-line hatching.

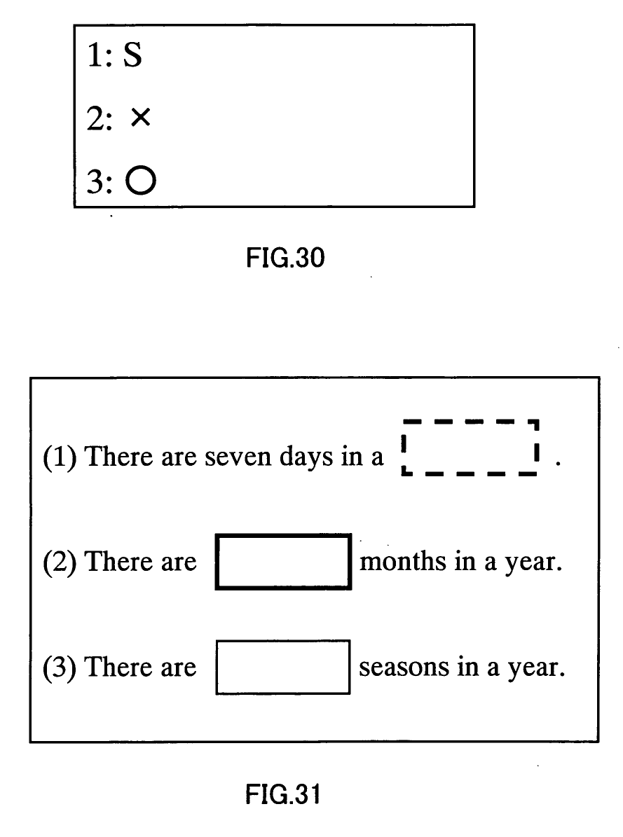

Furthermore, the answer determination results with respect to these questions are stored in the answer determination result memory 11 via the answer determination result holding part 10 in a form as shown in FIG. 30. In the answer determination results shown in FIG. 30, a symbol “S” represents misspelling, a symbol “X” represents a wrong word, and a symbol “◯” represents a correct answer. Then, when the next same question is displayed, the answer determination result fetching part 3 fetches the answer determination results from the answer determination result memory 11, and displays the question so as to make it understood which of the word and spelling is wrong in the previous answering, for example, in a form as shown in FIG. 31.

In the Example shown in FIG. 31, regarding the portion of misspelling (first question) in the previous answering, the answer box is displayed with a yellow line. In FIG. 31, the yellow line is represented with a thick broken line. Furthermore, regarding the portion (second question) of a wrong word in the previous answering, the answer box is displayed in red. In FIG. 31, the red line is represented with a thick solid line. The display form in accordance with the reason for wrongness is not limited to only the example shown in FIG. 31, and an arbitrary display form can be adopted as long as the reasons for wrongness can be discriminated from each other.

As described above, according to the present invention, a learning support system can be provided, in which answer determination results are stored in a form corresponding to a question, and the previous answer determination results are referred to, whereby in the case of displaying the same question, what kind of mistakes have been made in the previous learning is displayed separately. Thus, by displaying the kinds of the previous mistakes separately, the learner comes to give answers, paying attention to the questions to which the learner has given wrong answers, and the learning contents can be fixed without repeating the same mistake.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A learning support system including a question storing part for storing a question identifier, a question, and a correct answer so that they are associated with each other, a question display part for displaying a question fetched from the question storing part on a screen, and an answer input part for receiving an input of an answer to the question, comprising:
an answer determining part for matching the answer inputted from the answer input part with the correct answer in the question storing part and determining whether or not the answer inputted from the answer input part is correct;
an answer determination result display part for displaying answer determination results by the answer determining part so that they are associated with the answer inputted from the answer input part; and
an answer determination result storing part for storing the answer determination results by the answer determining part so that they are associated with the question identifier,
wherein the question display part displays a question whose answer determination results in previous answering are present in the answer determination result storing part, in a form in accordance with the answer determination results in the previous answering.

2. The learning support system according to claim 1, wherein the question display part displays the question whose answer determination results in the previous answering are present in the answer determination result storing part, in a form in accordance with the latest answer determination results.

3. The learning support system according to claim 1, wherein the answer determination result storing part stores a plurality of past answer determination results, and
the question display part displays the question whose answer determination results in the previous answering are present in the answer determination result storing part, in a form in accordance with a past correctness state obtained from the plurality of past answer determination results.

4. The learning support system according to claim 1, wherein the answer determination result display part refers to the answer determination result storing part, and displays answer determination results in a form so as to make it understood that a question to which a wrong answer has been given in the previous learning receives a correct answer.

5. The learning support system according to claim 1, wherein the answer determination result display part refers to the answer determination result storing part, and displays answer determination results in a form so as to make it understood that a question to which a wrong answer has been given in the previous learning receives a wrong answer again.

6. The learning support system according to claim 1, wherein the question storing part stores an answer limit time of each question regarding at least a part of questions,
the learning support system further comprises a timer for measuring a time required from a commencement of answering a question to a completion of inputting an answer,
the answer determination result storing part also stores information on whether or not the time measured by the timer exceeds the answer limit time together with the answer determination results, and
the question display part refers to the answer determination result storing part and displays questions in a form so that a question whose answer limit time has been exceeded in the previous learning is recognized.

7. The learning support system according to claim 1, wherein, in a case where a learner designates either one of the questions, the answer determination results and information regarding the designation by the leaner are stored in the answer determination result storing part, and
the question display part refers to the answer determination result storing part, and displays questions in a form so that the question designated by the learner in the previous learning is recognized.

8. The learning support system according to claim 1, wherein the answer input part includes an input device for allowing an answer to be inputted with handwriting, and
the learning support system further comprises a character/string recognizing part for referring to a character recognition dictionary to perform character/string recognition from the handwriting,
wherein the answer determining part refers to the recognition results by the character/string recognizing part and the correct answer in the question storing part to determine correctness.

9. The learning support system according to claim 1, wherein the answer input part includes an input device for allowing an answer to be inputted with handwriting, and
the answer determining part determines whether or not an answer is correct with respect to at least two elements selected from the group consisting of a shape of a character, a stroke order, the number of strokes, stop, and sweep-up, based on stroke information of the handwriting.

10. A computer-readable recording medium storing a learning support program for allowing a computer to execute:
a question display operation of displaying a question fetched from a question storing part storing a question identifier, a question, and a correct answer so that they are associated with each other on a screen;
an input operation of receiving an input of an answer to the question;
an answer determining operation of matching the inputted answer with the correct answer in the question storing part to determine whether or not the answer inputted from the answer input part is correct;
an answer determination result display operation of displaying the answer determination results so that they are associated with the answer inputted from the answer input part; and
an answer determination result storing operation of storing the answer determination results in an answer determination result storing part so that they are associated with the question identifier,
wherein the learning support program displays a question in a form in accordance with answer determination results in previous answering, regarding a question whose answer determination results in the previous answering are present in the answer determination result storing part in the question display operation.
